(19) United States
(12) Patent Application Publication
(10) Pub. No.: US 2015/0087165 A1
(43) Pub. Date: Mar. 26, 2015

(54) RECEPTACLE CONNECTOR WITH DOUBLE METALLIC SHELLS

(71) Applicant: ALLTOP ELECTRONICS (SUZHOU) LTD., Taicang City (CN)

(72) Inventors: Wang-I YU, Jhonghe City (TW); Hung-Chi TAI, Jhonghe City (TW); Ya-Juan GOU, Jhonghe City (TW); Dan LI, Jhonghe City (TW)

(73) Assignee: ALLTOP ELECTRONICS (SUZHOU) LTD., Taicang City (CN)

(21) Appl. No.: 14/134,354

(22) Filed: Dec. 19, 2013

(30) Foreign Application Priority Data
Sep. 22, 2013 (CN) 201310430527.3

(51) Int. Cl. H01R 13/502; H01R 12/91; H01R 12/71

(52) U.S. Cl. CPC H01R 13/502; H01R 12/716; H01R 12/91
USPC 439/78; 439/675; 439/377

(57) ABSTRACT

A receptacle connector includes an insulative housing, a number of contacts fixed to the insulative housing and a shell enclosing the insulative housing. The insulative housing includes a main portion, a mating portion and a fixing portion. The shell includes a first metallic shell and a second metallic shell fastened to the first metallic shell. The first metallic shell encloses the mating portion and cooperatively defines therebetween a mating space for receiving a plug connector. The second metallic shell defines a hollow space in which the first metallic shell is at least partly received. As a result, the first metallic shell and the second metallic shell have a strong structure which is stable for mating with the plug connector.

### BACKGROUND OF THE INVENTION

1. Field of the Invention

The present invention relates to a receptacle connector for being mounted to a circuit board, and more particularly to a receptacle connector with double metallic shells.

2. Description of Related Art

With rapid development of electronic technologies, electrical connectors have been widely used in electronic devices for exchanging information and data with external devices. A conventional connector usually includes an insulative housing, a plurality of contacts received in the insulative housing and a metallic shell enclosing the insulative housing. Each contact includes a soldering portion extending beyond the insulative housing for being soldered to a circuit board.

In order to meet the requirements of stable signal transmission and high effective transmission of the electronic devices, strong mating stabilization of the electrical connector needs to be ensured. However, a conventional MICRO HDMI receptacle connector usually defines multiple cutouts on a metallic shell and such cutouts are formed adjacent to a mating frame of the metallic shell. As a result, on one hand, the integral strength of the metallic shell is not good; on the other hand, when a plug connector is inserted into the MICRO HDMI receptacle connector, the plug connector might easily run away from the metallic shell and cause over-inclination, which will influence normal signal transmission.

Hence, a receptacle connector with improved metallic shell is desired.

### BRIEF SUMMARY OF THE INVENTION

The present invention provides a receptacle connector including an insulative housing, a plurality of contacts fixed to the insulative housing and a shell enclosing the insulative housing. The insulative housing includes a main portion, a mating portion extending forwardly from the main portion and a fixing portion extending rearwardly from the main portion. The mating portion includes an upper mating surface and a lower mating surface. The contacts include a plurality of first contacts each comprising a first contact portion exposed on the upper mating surface and a plurality of second contacts each comprising a second contact portion exposed on the lower mating surface. The shell includes a first metallic shell and a second metallic shell fastened to the first metallic shell. The first metallic shell encloses the mating portion and cooperatively defines therebetween a mating space for receiving a plug connector. The second metallic shell defines a hollow space in which the first metallic shell is at least partly received. As a result, the first metallic shell and the second metallic shell have a strong structure which is stable for mating with the plug connector.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

The components in the drawing are not necessarily drawn to scale, the emphasis instead being placed upon clearly illustrating the principles of the described embodiments. In the drawings, reference numerals designate corresponding parts throughout various views, and all the views are schematic.

FIG. 1 is a perspective view of a receptacle connector in accordance with an illustrated embodiment of the present invention;

FIG. 2 is an exploded view of the receptacle connector as shown in FIG. 1;

FIG. 3 is a perspective view of an insulative housing of the receptacle connector as shown in FIG. 2;

FIG. 4 is another perspective view of insulative housing as shown in FIG. 3 while taken from a different aspect;

FIG. 5 is a perspective view of one of first contacts of the receptacle connector as shown in FIG. 2;

FIG. 6 is a perspective view of a plurality of second contacts of the receptacle connector showing that the second contacts are connected together;

FIG. 7 is a perspective view of a first metallic shell of the receptacle connector as shown in FIG. 2; and

FIG. 8 is a perspective view of a second metallic shell of the receptacle connector as shown in FIG. 2.

### DETAILED DESCRIPTION OF THE PREFERRED EMBODIMENTS

Reference will now be made to the drawing figures to describe the embodiments of the present invention in detail. In the following description, the same drawing reference numerals are used for the same elements in different drawings.

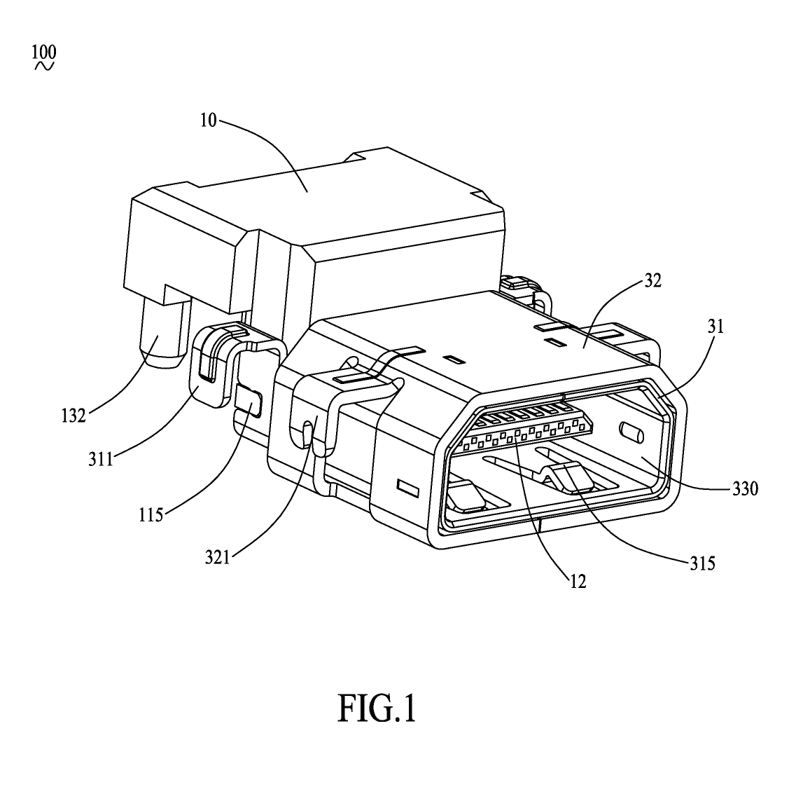

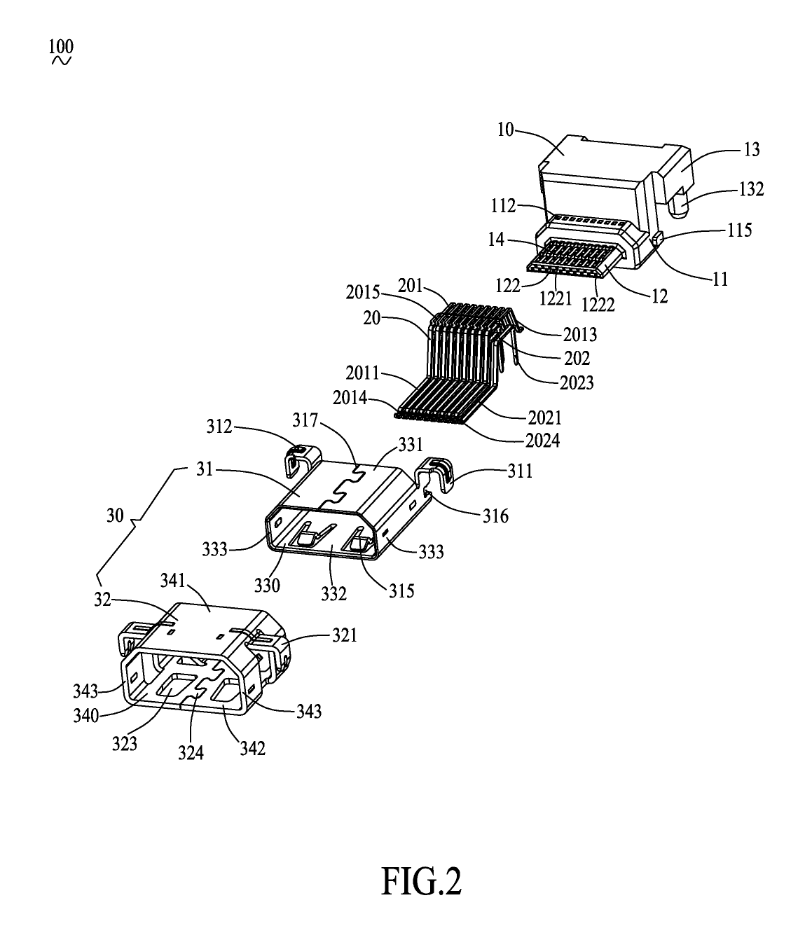

Referring to FIGS. 1 and 2, the present invention discloses a receptacle connector 100 for being mounted on a circuit board (not shown) for receiving a plug connector (not shown). The receptacle connector 100 is a Micro HDMI receptacle connector and the plug connector is a Micro HDMI plug connector according to an illustrated embodiment of the present invention. The receptacle connector 100 includes an insulative housing 10, a plurality of contacts 20 retained in the insulative housing 10 and a shell 30 enclosing the insulative housing 10. The contacts 20 include a plurality of first/upper contacts 201 and a plurality of second/lower contacts 202.

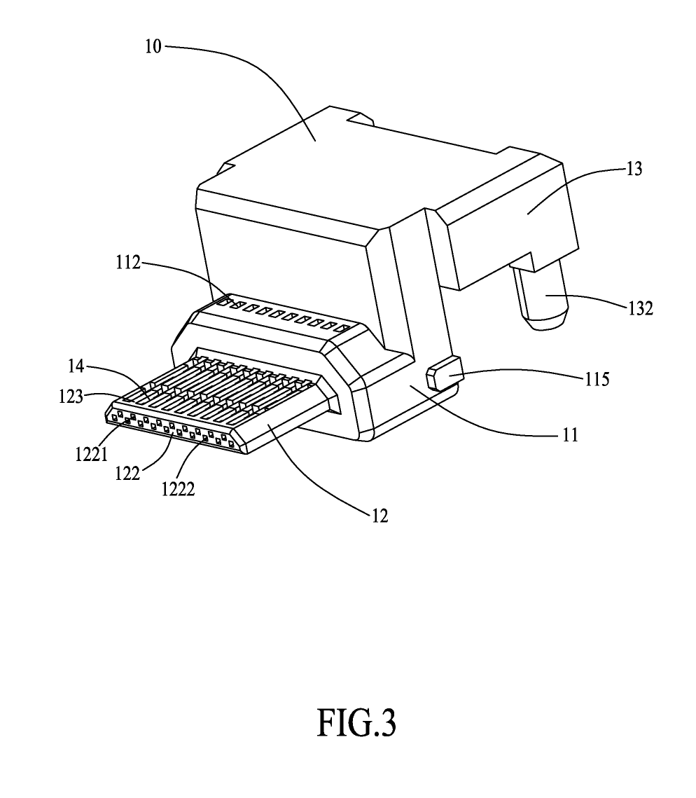

Referring to FIGS. 1 to 4, the insulative housing 10 includes a main portion 11, a mating portion 12 extending forwardly from the main portion 11 and a fixing portion 13 extending rearwardly from the main portion 11. The fixing portion 13 is higher than the main portion 11.

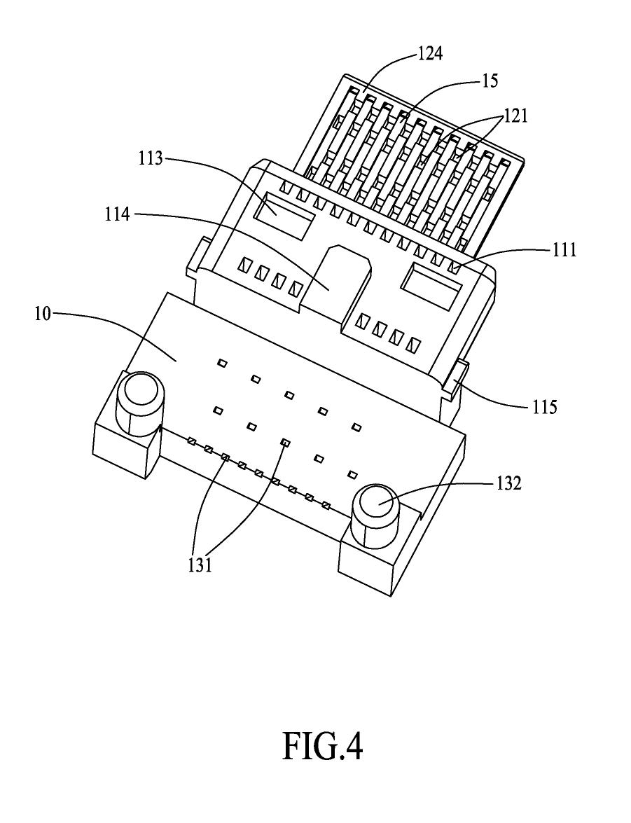

The insulative housing 10 includes a plurality of passageways for receiving the contacts 20. The passageways extend from a front end of the mating portion 12 towards the main portion 11. The passageways include a plurality of first passageways 14 for receiving the first contacts 201 and a plurality of second passageways 15 for receiving the second contacts 202. The first passageways 14 extend upwardly through an upper mating surface 123 of the mating portion 12. The second passageways 15 extend downwardly through a lower mating surface 124 of the mating portion 12. As shown in FIG. 4, the mating portion 12 further includes a plurality of grooves 121 extending through the mating portion 12 along a vertical direction in order to connect the first passageways 14 and the second passageways 15. As a result, heat generated by the first contacts 201 can be dissipated to the air through the grooves 121 and the first passageways 14. Similarly, heat generated by the second contacts 202 can be dissipated to the air through the grooves 121 and the second passageways 15.

The mating portion 12 includes a front-end surface 122 for mating with the plug connector. The front-end surface 122 defines a plurality of holes which further include a plurality of first holes 1221 in communication with the first passageways 14 and a plurality of second holes 1222 in communication with the second passageways 15. The first holes 1221 and the second holes 1222 are arranged along two layers along the vertical direction.

The main portion 11 defines a plurality of top apertures 111 in communication with the first passageways 14 and a plurality of bottom apertures 112 in communication with the second passageways 15. Heat generated by the first contacts 201 and the second contacts 202 can be dissipated to the air through the top apertures 111 and the bottom apertures 112, respectively.

The fixing portion 13 includes a plurality of holes 131 through which the first contacts 201 and the second contacts 202 extend. The fixing portion 13 includes a pair of mounting posts 132 at a rear side thereof. The mounting posts 132 extend downwardly towards the circuit board for being mounted through the circuit board. The main portion 11 includes a pair of recesses 113 on a bottom wall thereof and a position block 114 formed at a rear of the bottom wall. The pair of recesses 113 are located at opposite sides and at a front of the position block 114. Besides, the main portion 11 includes a pair of sideward blocks 115 on opposite side thereof.

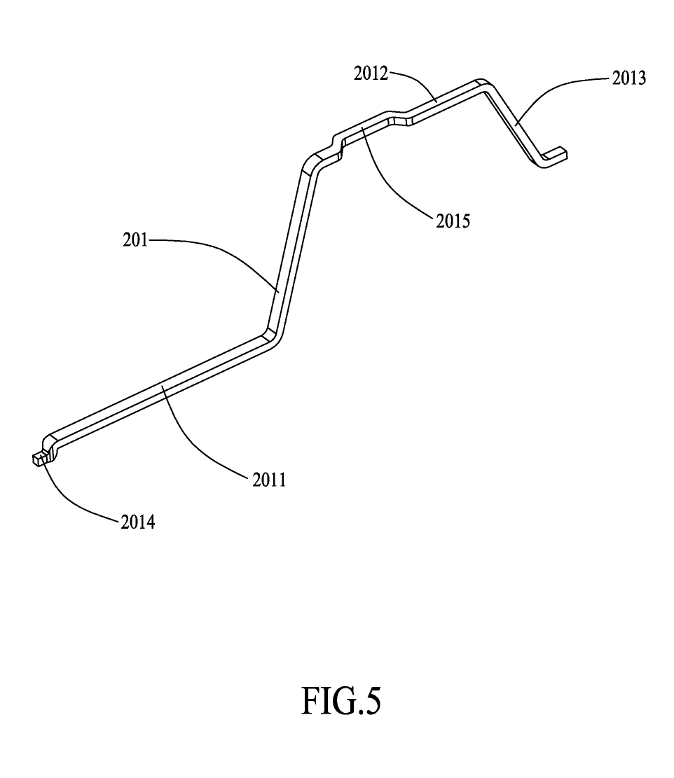

Referring to FIGS. 2 to 5, each first contact 201 includes a first contact portion 2011 exposed on the upper mating surface 123 of the mating portion 12, a first mounting portion 2013 for being soldered to the circuit board through SMT (Surface Mount Technology), and a first retaining portion 2012 connecting the first contact portion 2011 and the first mounting portion 2013. The first contact portion 2011 includes a first tip 2014 bent downwardly from a front end thereof and the first tip 2014 is received in corresponding first hole 1221. The first contact portions 2011 are received in the first passageways 14 and are exposed to the air. The first retaining portion 2012 includes an offset portion 2015 extending sidewardly along a horizontal direction.

Referring to FIGS. 2 to 4 and 6, each second contact 202 includes a second contact portion 2021 exposed on the lower mating surface 124 of the mating portion 12, a second mounting portion 2023 for being soldered through the circuit board, and a second retaining portion 2022 connecting the second contact portion 2021 and the second mounting portion 2023. The second contact portion 2021 includes a second tip 2024 bent upwardly from a front end thereof and the second tip 2024 is received in corresponding second hole 1222. The second contact portions 2021 are received in the second passageways 15 and are exposed to the air.

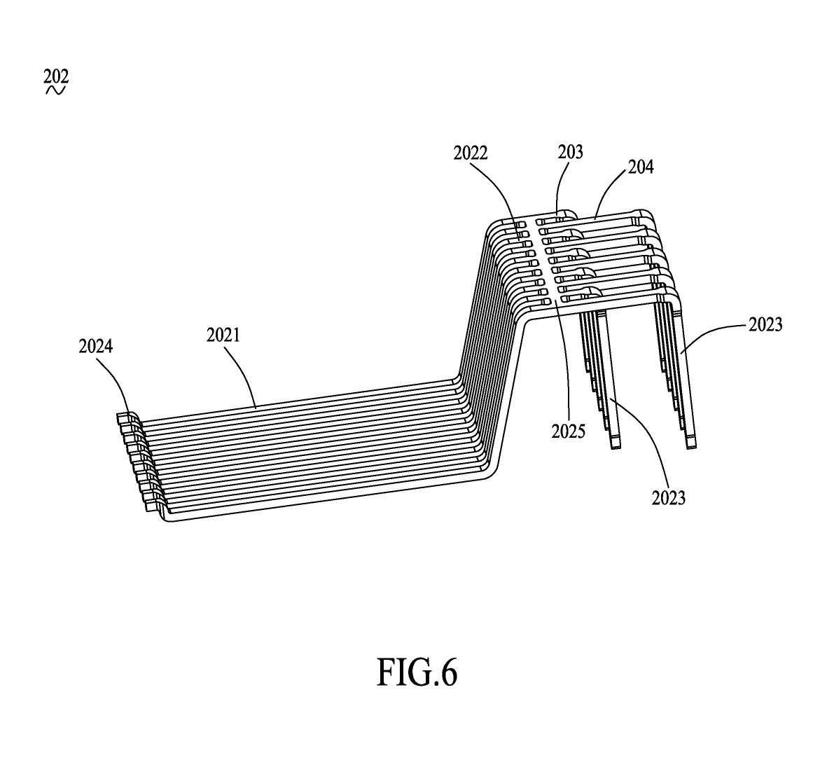

Referring to FIG. 6, the second contacts 202 includes a plurality of short contacts 203 and a plurality of long contacts 204 which are alternately arranged with the short contacts 203. The second contacts 202 further includes a connecting portion 2025 connecting the second retaining portions 2022 of the short contacts 203 and the long contacts 204. In this way, the second contacts 202 can be integrally assembled to the insulative housing 10. It is understandable that the connecting portion 2025 should be cut off so as to separate the second contacts 202 for different signal transmission. The second mounting portions 2023 are arranged in a first line and a second line along a front-to-back direction so that the second mounting portions 2023 can be securely soldered to the circuit board. The first mounting portions 2013 are arranged in a third line along the front-to-back direction.

It is understandable that the first contacts 201 and the second contacts 202 can be fixed to the insulative housing 10 either by insert-molding technology or by assembling technology.

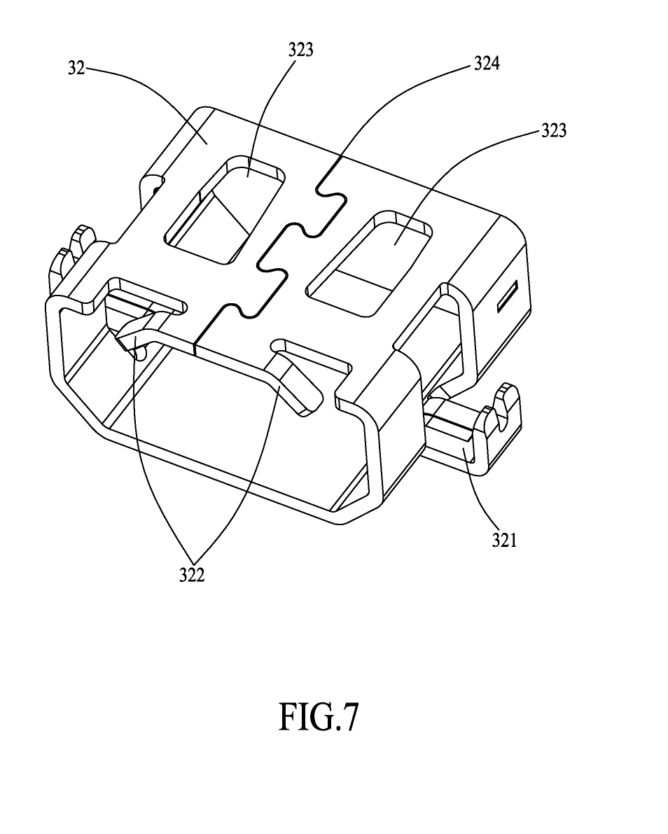

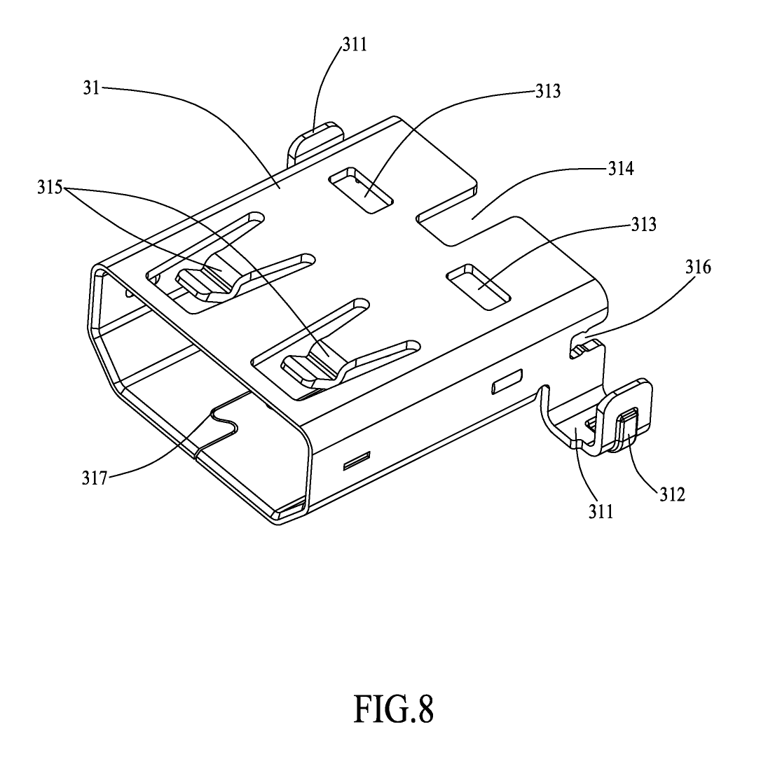

Referring to FIGS. 2 to 4, 7 and 8, the shell 30 includes a first metallic shell 31 and a second metallic shell 32 fastened to the first metallic shell 31. The first metallic shell 31 includes a first top wall 331, a first bottom wall 332 and a pair of first sidewalls 333 connecting the first top wall 331 and the first bottom wall 332. The first top wall 331, the first bottom wall 332 and the pair of first sidewalls 333 cooperatively define a mating space 330 in which the mating portion 12 resides. The first metallic shell 31 includes a pair of L-shaped first mounting legs 311 for being soldered to the circuit board. Each first mounting leg 311 includes a reinforce rib 312 for improving strength thereof. The first top wall 331 includes a first riveting portion 317 to joint/reinforce the first metallic shell 31. The first bottom wall 332 includes a pair of engaging arms 315 upwardly extending into the mating space 330 for abutting against the plug connector. Besides, the first bottom wall 332 includes a pair of slots 313 at the rear of the engaging arms 315 and a rear cutout 314 extending backwardly therethrough. Each first sidewall 333 includes a cutout 316 extending backwardly therethrough.

The second metallic shell 32 includes a second top wall 341, a second bottom wall 342 and a pair of second sidewalls 343 connecting the second top wall 341 and the second bottom wall 342. The second top wall 341, the second bottom wall 342 and the pair of second sidewalls 343 cooperatively define a hollow space 340. The second metallic shell 31 includes a pair of L-shaped second mounting legs 321 for being soldered to the circuit board. The L-shaped second mounting legs 321 are located at a middle portion of the second metallic shell 32. The second bottom wall 342 includes a second riveting portion 324 to joint/reinforce the second metallic shell 32. The second bottom wall 342 includes a pair of openings 323 through which the engaging arms 315 extend upwardly. Besides, the second bottom wall 342 includes a pair of beams 322 at a rear side thereof.

In assembling, the first metallic shell 31 is firstly assembled to the insulative housing 10 along the front-to-back direction. The sideward blocks 115 are fastened in the cutouts 316, and the position block 114 is fastened in the rear cutout 314. After the first metallic shell 31 is assembled in position, the slots 313 and the recesses 113 are in alignment with each other along the vertical direction. Then, the second metallic shell 32 is attached to the first metallic shell 31 along the front-to-back direction. As a whole, the second metallic shell 32 encloses the first metallic shell 31. When the second metallic shell 32 is assembled in position, the pair of beams 322 are located corresponding to the slots 313 and the recesses 113. Ultimately, the pair of beams 322 are stamped into the slots 313 and the recesses 113 so as to fasten the second metallic shell 32. As a result, the pair of beams 322 are of inclined configurations. Since the first riveting portion 317 and the second riveting portion 324 are located at top and bottom sides of the receptacle connector 100, respectively, the integral strength of the shell 30 can be well formed and balanced. The L-shaped second mounting legs 321, the L-shaped first mounting legs 311 and the mounting posts 132 are arranged along the front-to-back direction in turn. According to the illustrated embodiment of the present invention, the second metallic shell 32 is thicker than the first metallic shell 31 for better reinforcement. In a word, the shell 30 with the first metallic shell 31 and the second metallic shell 32 according to the illustrated embodiment of the present invention has a strong structure which is stable for mating with the plug connector.

It is to be understood, however, that even though numerous characteristics and advantages of preferred and exemplary embodiments have been set out in the foregoing description, together with details of the structures and functions of the embodiments, the disclosure is illustrative only; and that changes may be made in detail within the principles of present disclosure to the full extent indicated by the broadest general meaning of the terms in which the appended claims are expressed.

What is claimed is:

1. A receptacle connector for being mounted on a circuit board for mating with a plug connector, comprising:
an insulative housing comprising a main portion, a mating portion extending forwardly from the main portion and a fixing portion extending rearwardly from the main portion, the mating portion comprising an upper mating surface and a lower mating surface;
a plurality of contacts fixed to the insulative housing, the contacts comprising a plurality of first contacts each comprising a first contact portion exposed on the upper mating surface and a plurality of second contacts each comprising a second contact portion exposed on the lower mating surface;
a first metallic shell enclosing the mating portion and cooperatively defining therebetween a mating space for receiving the plug connector; and
a second metallic shell fastened to the first metallic shell, the second metallic shell defining a hollow space in which the first metallic shell is at least partly received.

2. The receptacle connector as claimed in claim 1, wherein the first metallic shell comprises a first top wall, a first bottom wall and a pair of first sidewalls connecting the first top wall and the first bottom wall, the mating space being enclosed by the first top wall, the first bottom wall and the pair of first sidewalls; and wherein
the second metallic shell comprises a second top wall, a second bottom wall and a pair of second sidewalls connecting the second top wall and the second bottom wall, the hollow space being enclosed by the second top wall, the second bottom wall and the pair of second sidewalls.

3. The receptacle connector as claimed in claim 2, wherein the first top wall defines a first riveting portion to joint the first metallic shell, the second bottom wall defines a second riveting portion to joint the second metallic shell, and the first riveting portion and the second riveting portion are located at top and bottom sides of the receptacle connector, respectively.

4. The receptacle connector as claimed in claim 2, wherein the first metallic shell comprises a pair of L-shaped first mounting legs for being soldered to the circuit board, and the second metallic shell comprises a pair of L-shaped second mounting legs for being soldered to the circuit board as well.

5. The receptacle connector as claimed in claim 4, wherein the pair of L-shaped first mounting legs are located at a rear end of the first metallic shell and the pair of L-shaped second mounting legs are located at a middle portion of the second metallic shell.

6. The receptacle connector as claimed in claim 2, wherein the main portion comprises a pair of sideward blocks, and the pair of first sidewalls define a pair of cutouts to securely fasten the sideward blocks, the pair of cutouts being positioned adjacent to the L-shaped first mounting legs.

7. The receptacle connector as claimed in claim 2, wherein the first bottom wall comprises a pair of engaging arms, and the second bottom wall comprises a pair of openings through which the engaging arms extend upwardly.

8. The receptacle connector as claimed in claim 2, wherein the first bottom wall defines a rear cutout, and the main portion comprises a position block securely fastened in the rear cutout.

9. The receptacle connector as claimed in claim 8, wherein the first bottom wall defines a pair of slots, the main portion defines a pair of recesses in alignment of the pair of slots along a vertical direction, and the second bottom wall comprises a pair of inclined beams protruding into corresponding slots and the recesses in order to fasten the second metallic shell.

10. The receptacle connector as claimed in claim 1, wherein each first contact comprises a first retaining portion and a first mounting portion, each second contact comprises a second retaining portion and a second mounting portion, and the first mounting portions are mounted to the circuit board through SMT (Surface Mount Technology) while the second mounting portions are mounted through the circuit board.

11. The receptacle connector as claimed in claim 10, wherein the second mounting portions are arranged in a first line and a second line along a front-to-back direction, and the first mounting portions are arranged in a third line along the front-to-back direction.

12. The receptacle connector as claimed in claim 10, wherein the main portion defines a plurality of top apertures through which the first retaining portion are exposed to an exterior and a plurality of bottom apertures through which the second retaining portion are exposed to the exterior.

13. The receptacle connector as claimed in claim 4, wherein the fixing portion comprises a pair of mounting posts which extend through the circuit board for mounting the receptacle connector to the circuit board; and wherein the L-shaped second mounting legs, the L-shaped first mounting legs and the mounting posts are arranged along a front-to-back direction in turn.

14. The receptacle connector as claimed in claim 1, wherein the second metallic shell is thicker than the first metallic shell.

15. A receptacle connector comprising:
an insulative housing comprising a main portion, a mating portion extending forwardly from the main portion and a fixing portion extending rearwardly from the main portion, the fixing portion being higher than the main portion and comprising a pair of mounting posts;
a plurality of contacts fixed to the insulative housing;
a first metallic shell enclosing the mating portion and comprising a pair of first mounting legs; and
a second metallic shell fastened to the first metallic shell, the second metallic shell comprising a pair of second mounting legs and a hollow space in which the first metallic shell is at least partly received; wherein
the second mounting legs, the first mounting legs and the mounting posts are arranged along a front-to-back direction in turn for being fixed to a circuit board.

16. The receptacle connector as claimed in claim 15, wherein the first metallic shell comprises a first top wall, a first bottom wall, a pair of first sidewalls connecting the first top wall and the first bottom wall, and a mating space enclosed by the first top wall, the first bottom wall and the pair of first sidewalls; and wherein
the second metallic shell comprises a second top wall, a second bottom wall and a pair of second sidewalls connecting the second top wall and the second bottom wall, the hollow space being enclosed by the second top wall, the second bottom wall and the pair of second sidewalls.

17. The receptacle connector as claimed in claim 16, wherein the first top wall defines a first riveting portion to joint the first metallic shell, the second bottom wall defines a second riveting portion to joint the second metallic shell, and the first riveting portion and the second riveting portion are located at top and bottom sides of the receptacle connector, respectively.

18. The receptacle connector as claimed in claim 16, wherein the first mounting legs and the second mounting legs are L-shaped, the first mounting legs are located at a rear end of the first metallic shell, and the second mounting legs are located at a middle portion of the second metallic shell.

19. The receptacle connector as claimed in claim 16, wherein the first bottom wall defines a pair of slots, the main portion defines a pair of recesses in alignment of the pair of slots along a vertical direction, and the second bottom wall comprises a pair of inclined beams protruding into corresponding slots and the recesses in order to fasten the second metallic shell.

20. The receptacle connector as claimed in claim 15, wherein the second metallic shell is thicker than the first metallic shell.
